(19) United States
(12) Patent Application Publication
(10) Pub. No.: US 2023/0223854 A1
(43) Pub. Date: Jul. 13, 2023

(54) CONVERTER

(71) Applicant: PULSIV LIMITED, Cambridge (GB)

(72) Inventor: Mohammed Zaki Ahmed, Cambridge (GB)

(73) Assignee: PULSIV LIMITED, Cambridge (GB)

(21) Appl. No.: 18/009,014

(22) PCT Filed: Jun. 10, 2021
(86) PCT No.: PCT/GB2021/051449

§ 371 Date: Dec. 8, 2022

(30) Foreign Application Priority Data
Jun. 11, 2020 (GB) 2008869.6

(51) Int. Cl. H02M 3/335; H02M 1/34

(52) U.S. Cl. CPC H02M 3/33546; H02M 3/33507; H02M 1/342

(57) ABSTRACT

A flyback converter and forward converter is described that include an input coil, a primary switch connected in series with the input coil, and an output coil magnetically coupled to the input coil. The input coil has an input side connected to an input of the circuit and a switch side connected to the primary switch. The converter further includes an input side clamp circuit, the input side clamp circuit including an energy store and a switch arrangement controlled such that the leakage inductance energy stored, in use, in the energy store, can be discharged to the input side of the input coil.

This invention relates to a flyback converter or a forward converter, and in particular to a converter designed in such a manner as to achieve performance or efficiency advantages.

Flyback converters and forward converters are in common use where DC-DC conversion is required, and can also form parts of AC-DC converters where some DC-DC conversion is required. They are of particular benefit in applications in which there is a desire to provide galvanic isolation between an input side of the converter and an output side thereof.

A typical flyback converter takes the form of an input coil magnetically coupled to an output coil, a switch being provided in series with the input coil. A diode and smoothing capacitor are connected to the output coil. In use, the switch is repeatedly opened and closed at a high frequency, for example at switching frequencies of the order of 100 kHz, although some schemes that operate at lower frequencies, for example in the 50-100 kHz range, are known. When the switch is closed the input coil, which is directly connected to the associated voltage source, experiences an increase in the current and magnetic flux associated therewith, and energy is stored therein. The voltage induced in the output coil in this phase of the operation of the converter is negative, and so the diode connected to the output coil is reverse-biased, preventing current flow through the output coil. The output from the converter is satisfied from discharging of the smoothing capacitor.

When the switch is opened, the input coil current and associated magnetic flux drops. The output coil voltage is positive, forward-biasing the diode, allowing current to flow from the converter to the load, and to recharge the capacitor.

It will be appreciated that, by repeatedly switching the switch between its open and closed positions, a varying DC output will be supplied from the circuit which is isolated from the input or supply.

One disadvantage with coupled-coils converters such as flyback converters is that in order to be of small size and high output, the switching frequency needs to be high. However, increasing the switching speed reduces the efficiency of the converter as the effects of the leakage inductance become significant. This is especially true where the converter is used in AC-DC conversion applications. Similarly, leakage induction limits the use of forward converters.

One attempt to address this issue is to provide a so-called active clamp which involves connecting a capacitor across the input coil, a switch being provided to control the timing of charging and discharging of the capacitor. When the main switch of the converter is opened, the capacitor is allowed to discharge through the input coil. In this manner, the output from the leakage inductance which would otherwise be lost, for example as heat, can be stored in the capacitor and subsequently supplied through the coils of the converter to the output during intervals when the switch is open.

Whilst the provision of such an active clamp arrangement is advantageous, the switching components used therein are relatively complex and expensive, and the efficiency enhancements achieved are relatively small as the magnetic coupling between the input and output coils is not optimal for transmission of the stored leakage inductance energy to the output when operated in the manner outlined hereinbefore when the main switch is open.

It is an object of the invention to provide a coupled inductance converter, such as a flyback converter, or a forward converter, of enhanced operating efficiency.

According to one aspect of the present invention, there is provided a converter circuit for use in a coupled inductance converter, the converter circuit comprising an input coil, a primary switch connected in series with the input coil, the input coil being arranged to allow it to be magnetically coupled with an output coil to the provided, the input coil having an input side connected to an input of the circuit and a switch side connected to the primary switch, and further comprising an input side clamp circuit, the input side clamp circuit comprising an energy store and a switch arrangement controlled such that the leakage inductance energy stored, in use, in the energy store, can be discharged to the input side of the input coil.

In embodiments, a converter uses the converter circuit and an output coil magnetically coupled to the input coil.

According to another aspect of the present invention there is provided a converter, or coupled-inductance converter, configured as a flyback converter or as a forward converter, the converter comprising an input coil, a primary switch connected in series with the input coil, and an output coil magnetically coupled to the input coil, the input coil having an input side connected to an input of the circuit and a switch side connected to the primary switch, and further comprising an input side clamp circuit, the input side clamp circuit comprising an energy store and a switch arrangement controlled such that the leakage inductance energy stored, in use, in the energy store, can be discharged to the input side of the input coil.

In the above aspects, discharge of the energy store may take place, under the control of the switch arrangement of the input side clamp circuit, when the primary switch is closed.

In effect, the discharge of the energy store supplements the input to the flyback converter or forward converter, passing through the coils thereof in a direction and at a point in the operating cycle of the flyback converter or forward converter, respectively, at which conversion is optimised. As a result, considering the example of a flyback converter, the leakage inductance output may be used more efficiently, and so the flyback converter can be of enhanced efficiency both when compared to a traditional flyback converter and when compared to a flyback converter including an active clamp. Likewise, considering another example in the form of a forward converter, the leakage inductance of a forward converter arrangement can be used more efficiently by way of the present design. Furthermore, the additional components required to put the invention into effect are relatively simple and low cost components, and so the enhanced efficiency can be achieved in a simple and low cost manner.

The energy store conveniently takes the form of a capacitor. The switch arrangement conveniently comprises a diode and a controlled switch such as a MOSFET. However, this need not be the case and the switch could take other forms, and the diode could be replaced by a suitably controlled MOSFET or the like. In some embodiments, the switch arrangement comprises one or more Gallium Nitride (GaN) switches, or other switch arrangements capable of providing switching frequencies in the high kHz region, in the MHz region, or higher. The switch arrangement may thus be configured to operate at a switching frequency fs of at least 100 kHz, at least 1 MHz, at least 10 MHz, or at least 100 Mhz.

At high switching frequencies, the coils may be provided without being wound around a magnetic core structure. In that case, the input coil and the output coil may are printed on a circuit board. The input coil and the output coil may be coupled without reliance on a magnetic core structure. The input coil and the output coil may be located on different components. In this manner, the invention may be used as part of a wireless charging arrangement. It will be appreciated that in the case of being located on different components, the components are separable to reduce coupled inductance between the input coil and the output coil, and/or may be configured to allow arrangement of the components to be seated against each other, or relative to each other, in a position that allows coupled inductance to occur between the input coil and the output coil.

The invention may be used in a flyback converter or in a forward converter.

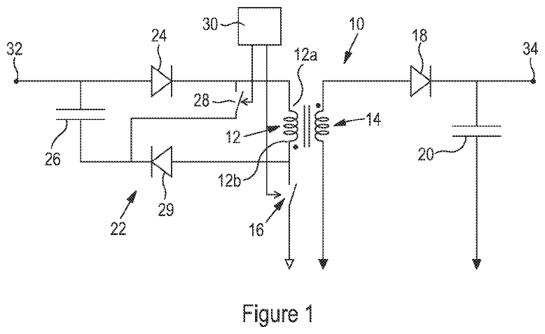

The invention will further be described, by way of example, which in the present FIG. 1 relates to a flyback converter, with reference to the accompanying drawing, FIG. 1, which is a simplified circuit diagram illustrating a flyback converter in accordance with an embodiment of the invention.

Referring to FIG. 1, a flyback converter circuit 10 in accordance with an embodiment of the invention is illustrated. The converter circuit 10 comprises an input coil 12 magnetically coupled to an output coil 14. A primary switch 16 is connected in series with the input coil 12. The input coil 12 thus has an input side 12a connected to an input 32, and a switch side 12b connected to the primary switch 16.

The output coil 14 is connected in series with a diode 18 to an output 34 to which a load is connected, in use, and a smoothing capacitor 20 is provided.

In accordance with the invention, an input clamp circuit 22 is connected across the input coil 12. The input clamp circuit 22 comprises a diode 24 connected between the input 32 and the input side 12a of the input coil 12, an energy storage device in the form of a capacitor 26 connected across the input coil 12, a diode 29 connecting the capacitor 26 to the switch side 12b of the input coil 12, and an active switch 28, for example in the form of a MOSFET. Rather than provide an active switch such as a MOSFET, an alternative switch or switching circuit could be used. In embodiments, a GaN switching arrangement may be used.

A control unit 30 is provided, controlling the operation of the primary switch 16 and the active switch 28 of the input clamp circuit 22.

In use, with an input supply connected to the input 32 of the circuit and a load connected across the output 34 thereof, the control unit 30 is used to move the primary switch 16 and the active switch 28 of the input clamp circuit 22 between their respective open and closed positions at a high switching frequency, for example at a frequency in the region of 100 kHz or higher, the control unit 30 synchronising the operation of the primary switch 16 and the active switch 28 of the input clamp circuit 22. Whilst it is envisaged to use a switching frequency of this magnitude, it will be appreciated that lower switching frequencies, for example in the range of 50-100 kHz, could be used. Using appropriate switch arrangements such as GaN switches, higher switching frequencies in the MHz region, or higher, could be used.

Starting from a condition in which the primary switch 16 is closed, current flows from the input 32 though the diode 24, input coil 12 and primary switch 16, the current rising and increasing the magnetic flux in the input coil 16, and energy is thus stored in the input coil 16. During this phase of the operating cycle, the diode 18 serves to prevent current flow through the output coil 14, and the load is satisfied through discharge of the smoothing capacitor 20.

Upon opening of the primary switch 16, the magnetic coupling between the input and output coils 12, 14 induces a current in the output coil 14 that can pass through the diode 18, serving to satisfy the load and recharge the smoothing capacitor 20.

It will be appreciated that this manner of operation is the same as for a conventional flyback converter. However, in accordance with the invention, the leakage inductance arising when the primary switch 16 is opened gives rise to a current which, with the active switch 28 of the input clamp circuit 22 controlled so as to be open, and by virtue of the presence of the diodes 24, 29, results in energy storage by the capacitor 26.

Upon subsequent closing of the active switch 28 of the input clamp circuit 22 and of the primary switch 16 under the control of the control unit 30, the capacitor 26 can discharge through the active switch 28 to the input side 12a of the input coil 12, supplementing the input supply through the diode 24 in increasing the current flow, and hence the magnetic flux within the input coil 12, and so enhancing the level of energy stored within the input coil 12 for extraction upon subsequent opening of the primary switch 16.

It will be appreciated that in accordance with the invention, the capacitor 26 of the input side current clamp circuit 22 discharges to the input side 12a of the input coil 12, rather than to the switch side 12b thereof as is the case with a conventional active clamp flyback arrangement, and the timing of the discharge of the capacitor 26 is changed accordingly. As the discharge of the capacitor 26 is to the input side 12a of the input coil 12, it will be appreciated that during discharge of the capacitor 26, the magnetic circuit is operating efficiently in the manner in which it was designed to function, as compared to an active clamp flyback arrangement in which the capacitor discharges to the switch side of the input coil, and the magnetic structure functions in an inefficient manner. Consequently, efficiency benefits can be obtained through the use of the converter of the present invention.

By repeatedly switching the primary switch 16 and the active switch 28 in the manner set out hereinbefore, it will be appreciated that a varying DC output is experienced by the load in substantially the same manner as would be the case with a traditional flyback converter, but with an enhanced level of efficiency. The enhanced efficiency may result in a reduction in heat generated in use, which can lead to other benefits such as a reduction in cooling requirements, easing of packaging constraints and a reduction in space requirements. Where used in, for example, a power supply for a device, the power supply may thus be of reduced dimensions.

It is envisaged that the diodes 24, 29 and active switch 28 could be incorporated into a simple integrated circuit, if desired.

Whilst in the description hereinbefore, diodes 24, 29 are provided, it will be appreciated that as such a component can be relatively inefficient, it may be preferred to substitute the diode 24 and/or the diode 29 with a suitably controlled active switch, by way of example in the form of a MOSFET or the like, conveniently controlled, in use, by the control unit 30 so as to maintain synchronism with the operation of the other switches.

The capacitor 26 may, in one example embodiment, be of 100 nF size, the input coil of 470 μH inductance and the output coil of 10.47 μH inductance, but it will be appreciated that this invention is not restricted in this regard and other component sizes may be used depending upon the application in which the invention is to be used and the requirements thereof.

Whilst in the circuit illustrated, the switches 16, 28 are controlled independently through respective control lines from the control unit 30, it will be appreciated that they could be commonly controlled from a single output from the control unit 30, which may allow the control unit 30 to be of a simpler design and may potentially allow cost savings to be made.

While the example of FIG. 1 describes the operation of a flyback converter, it will be appreciated that a similar principle will apply when configuring and controlling a forward converter so as to route leakage inductance to the input side of the input coil. It will be understood that in contrast to the FIG. 1 illustration, an illustration for a forward converter will show one coil wound in the opposite winding sense compared to FIG. 1 (i.e. a diagrammatic “dot” on the same side for input and output coils for a forward converter).

Using GaN switches, switching frequencies in the MHz region may be used, higher than in the example above. As the size that is required of the magnetic structure for the coils correlates with squared relationship with the switching frequency, switching frequencies in the MHz region that are achievable with GaN switches may avoid the need for a magnet structure such as a transformer core altogether. Instead, the flyback converter or forward converter of the present invention may rely on inherent magnetic effects of the input and output coils. Indeed, the input and output coils may be copper materials, or other materials as typically used on, or printed onto, a circuit board. In that case, instead of being wound around a core structure, the coils may be appropriately positioned and appropriately spaced apart to allow coupling to occur.

It will be appreciated that the omission of a magnetic core structure is expected to lead to relatively high leakage inductance, typically in the region of 10% or more. Using conventional active clamp designs, such a level of leakage inductance would be considered inacceptable. In contrast, by way of the present invention, leakage inductance is effectively “re-routed”, via the input side 12a of the input coil 12, thereby allowing higher leakage inductance to be tolerated that is expected as a consequence of weaker coupling.

By being able to omit a core structure, the input and output coils may be separated. The input and output coils may be located on separate components. This allows the coupled inductance converter described herein to be used for wireless charging. It will be appreciated that, in that case, a control arrangement such as the control unit 30 may be configured to stop charging beyond a pre-determined end point. E.g., once an energy store reaches a pre-determined level of capacity, or full capacity, the control arrangement may be configured to charge no further, or no more than at a level required to maintain the pre-determined level of capacity or full capacity. In that case, the control arrangement may be configured to top up, in regular intervals or continuously, to a pre-determined level of capacity or full capacity.

In embodiments, particularly in wireless converter/charger embodiments, the invention may be embodied by a converter circuit comprising the input coil side depicted in FIG. 1, the converter circuit comprising an input coil, a primary switch connected in series with the input coil, the input coil being arranged to allow it to be magnetically coupled with an output coil to the provided, the input coil having an input side connected to an input of the circuit and a switch side connected to the primary switch, and further comprising an input side clamp circuit, the input side clamp circuit comprising an energy store and a switch arrangement controlled such that the leakage inductance energy stored, in use, in the energy store, can be discharged to the input side of the input coil.

It will be understood that the coupled inductance will occur, in that case, when an output coil, for instance of a separate consumer electronics device, is appropriately coupled, and when the converter circuit is operated in a controlled-discharge manner as provided by the present invention.

Whilst specific embodiments of the invention have been described hereinbefore, it will be appreciated that a wide range of modifications and alterations may be made thereto without departing from the scope of the invention as defined by the appended claims.

1. A converter circuit for use in a coupled inductance converter, the converter circuit comprising an input coil, a primary switch connected in series with the input coil, the input coil being arranged to allow it to be magnetically coupled with an output coil to the provided, the input coil having an input side connected to an input of the circuit and a switch side connected to the primary switch, and further comprising an input side clamp circuit, the input side clamp circuit comprising an energy store and a switch arrangement controlled such that leakage inductance energy stored, in use, in the energy store, can be discharged to the input side of the input coil.

2. The converter circuit according to claim 1, configured such that discharge of the energy store takes place, under the control of the switch arrangement of the input side clamp circuit, when the primary switch is closed.

3. The converter circuit according to claim 1, wherein the energy store takes the form of a capacitor.

4. The converter circuit according to claim 1, wherein the switch arrangement comprises a diode and a controlled switch.

5. The converter circuit according to claim 4, wherein the controlled switch comprises a MOSFET.

6. The converter circuit according to claim 4, wherein the controlled switch comprises a GaN switch.

7. The converter circuit according claim 4, wherein the switch arrangement comprises an integrated circuit.

8. The converter circuit according to claim 1, wherein the switch arrangement is configured to operate at a switching frequency of one of at least 100 kHz, at least 1 MHz, at least 10 MHz, and at least 100 Mhz.

9. The converter comprising the converter circuit according to claim 1, and further comprising an output coil magnetically coupled to the input coil.

10. A converter configured as one of a flyback converter and a forward converter, the converter comprising an input coil, a primary switch connected in series with the input coil, and an output coil magnetically coupled to the input coil, the input coil having an input side connected to an input of the circuit and a switch side connected to the primary switch, and further comprising an input side clamp circuit, the input side clamp circuit comprising an energy store and a switch arrangement controlled such that leakage inductance energy stored, in use, in the energy store, can be discharged to the input side of the input coil.

11. The converter according to claim 10, wherein the input coil and the output coil are printed on a circuit board.

12. The converter according to claim 10, wherein the input coil and the output coil are couplable without reliance on a magnetic core structure.

13. The converter according to claim 10, wherein the input coil and the output coil are located on different components.

14. The converter according to claim 13, wherein the different components are separable to reduce coupled inductance between the input coil and the output coil.

15. The converter according to claim 13, wherein the different components are arranged to be seated relative to each other in a position that allows coupled inductance to occur between the input coil and the output coil.

16. The converter according to claim 10, implemented as a flyback converter.

17. The converter according to claim 10, implemented as a forward converter.
